(19) United States
(12) Patent Application Publication
(10) Pub. No.: US 2009/0272235 A1
(43) Pub. Date: Nov. 5, 2009

(54) TUBULAR HANDLING SYSTEM

(76) Inventor: Joe Berry, Houston, TX (US)

Correspondence Address: OSHA LIANG L.L.P., TWO HOUSTON CENTER, 909 FANNIN, SUITE 3500, HOUSTON, TX, 77010, US

(21) Appl. No.: 12/434,483

(22) Filed: May 1, 2009

Related U.S. Application Data
(60) Provisional application No. 61/049,572, filed on May 1, 2008.

(51) Int. Cl. B25B 13/50; E21B 19/16

(52) U.S. Cl. 81/57.34; 29/428; 166/380

(57) ABSTRACT

A tubular handling system includes a plurality of roller units configured to engage and rotate a first tubular, wherein the roller units are configured to adjust about a concentric center of the first tubular. The tubular handling system further includes an upper jaw assembly including a double-acting gripping cylinder, the upper jaw assembly configured to grip the first tubular, a lower jaw assembly including a double-acting gripping cylinder, the lower jaw assembly configured to grip a second tubular, a first torque cylinder configured to rotate the upper jaw assembly in a first direction relative to the lower jaw assembly, and a second torque cylinder configured to rotate the lower jaw assembly in an opposite direction relative to the upper jaw assembly.

### CROSS REFERENCE TO RELATED APPLICATIONS

This application claims the priority of a provisional application under 35 U.S.C. §119(e), namely U.S. Patent Application Ser. No. 61/049,572 filed on May 1, 2008, which is incorporated by reference in its entirety herein.

### BACKGROUND

1. Field of the Disclosure

Embodiments disclosed herein relate generally to tubular handling systems. More particularly, embodiments disclosed herein relate to apparatus and methods to connect and disconnect tubular members.

2. Background Art

An “iron roughneck” is a commonly-known piece of equipment used in the oil industry to make-up or break-out threaded tubular connections. An iron roughneck may combine a torque wrench and a spinner assembly to connect and disconnect threaded connections when running a string of tubulars into or out of a well.

Various iron roughnecks may have a spinner assembly and a torque wrench mounted together on a carriage. For making or breaking threaded connections between two tubulars, (e.g., joints of drill tubular), certain iron roughnecks may have a torque wrench with two jaw levels. An upper jaw of the torque wrench may clamp onto a portion of an upper tubular of a threaded connection, and a lower jaw may clamp onto a portion of a lower tubular of a threaded connection.

After clamping onto the tubulars, the upper and lower jaws of the torque wrench are rotated relative to each other about the axis of the tubulars to break or make a connection between the upper and lower tubulars. In a break-out operation, a spinner assembly, mounted on the carriage above the torque wrench, may engage the upper tubular following initial break-out by the torque wrench and spin it until it is disconnected from the lower tubulars. In a connection operation, the spinner may spin two tubulars together prior to final make-up by the torque wrench. Certain iron roughnecks may be mounted for movement from a wellbore center to a retracted position which does not interfere with or block performance of other operations relative to the well and rotating or driving apparatuses.

FIGS. 1A and 1B depict a tubular handling system 10 in accordance with the prior art. Tubular handling system 10 includes a carriage 50 which is movably connected for up/down vertical movement to a column 52, and which may also translate horizontally on a rig floor 60 for movement toward and away from a drill tubular 70 in a well. Tubular handling system 10 also includes support arms 54, 56 (two each) which are pivotably connected at one end to a base (not shown) of carriage 50. Tubular handling system 10 includes a spinner assembly 80 and a torque wrench 90 which are attached to the carriage 50, and may be extended to engage drill tubular 70, as shown in FIG. 1B.

In certain instances, different diameter tubulars may be used in a string, requiring manual adjustments to the spinner assembly to receive the different tubular diameters. This, in turn, may slow the operation and increase rig time costs. Further, previous tubular handling systems may not provide enough force to secure the tubular when making-up or breaking-out the connections. Accordingly, there exists a need for apparatus that provide sufficient gripping force when making up or breaking out connections. Further, automatically adjustable apparatus configured to receive different tubular diameters would be well received in industry.

### SUMMARY OF THE DISCLOSURE

In one aspect, embodiments disclosed herein relate to a tubular handling system including a plurality of roller units configured to engage and rotate a first tubular, wherein the roller units are configured to adjust about a concentric center of the first tubular. The tubular handling system further includes an upper jaw assembly including a double-acting gripping cylinder, the upper jaw assembly configured to grip the first tubular, a lower jaw assembly including a double-acting gripping cylinder, the lower jaw assembly configured to grip a second tubular, a first torque cylinder configured to rotate the upper jaw assembly in a first direction relative to the lower jaw assembly, and a second torque cylinder configured to rotate the lower jaw assembly in an opposite direction relative to the upper jaw assembly.

In another aspect, embodiments disclosed herein relate to a tubular handling system including an upper jaw assembly including a double-acting gripping cylinder, the upper jaw assembly configured to grip the first tubular, a lower jaw assembly including a double-acting gripping cylinder, the lower jaw assembly configured to grip a second tubular, a first torque cylinder configured to rotate the upper jaw assembly in a first direction relative to the lower jaw assembly, and a second torque cylinder configured to rotate the lower jaw assembly in an opposite direction relative to the upper jaw assembly.

In another aspect, embodiments disclosed herein relate to a tubular handling system including a plurality of roller units attached to arms, the roller units configured to engage and rotate a first tubular, a gear mechanism configured to engage ends of the arms, wherein the gear mechanism is configured to open and close the arms, and wherein the arms are configured to maintain the roller units about a concentric center of the first tubular.

In another aspect, embodiments disclosed herein relate to a method to make-up a tubular connection, the method including engaging a first tubular with a plurality of automatically adjustable roller units, wherein the roller units are configured to concentrically center about a center of the first tubular, rotating the first tubular with multiple rollers mounted on the roller units, activating a double-acting cylinder connected to a lower jaw assembly to secure a second tubular, activating a double-acting cylinder connected to an upper jaw assembly to secure the first tubular, and rotating the upper jaw assembly and the lower jaw assembly in opposite directions to make-up the tubular connection.

Other aspects and advantages of the invention will be apparent from the following description and the appended claims.

### BRIEF DESCRIPTION OF DRAWINGS

FIGS. 1A and 1B are assembly views of a typical tubular handling system.

FIGS. 2A and 2B are assembly views of a torque wrench in accordance with embodiments of the present disclosure.

FIG. 3 is an assembly view of a jaw assembly in accordance with embodiments of the present disclosure.

FIGS. 4A and 4B are assembly views of a spinner in accordance with embodiments of the present disclosure.

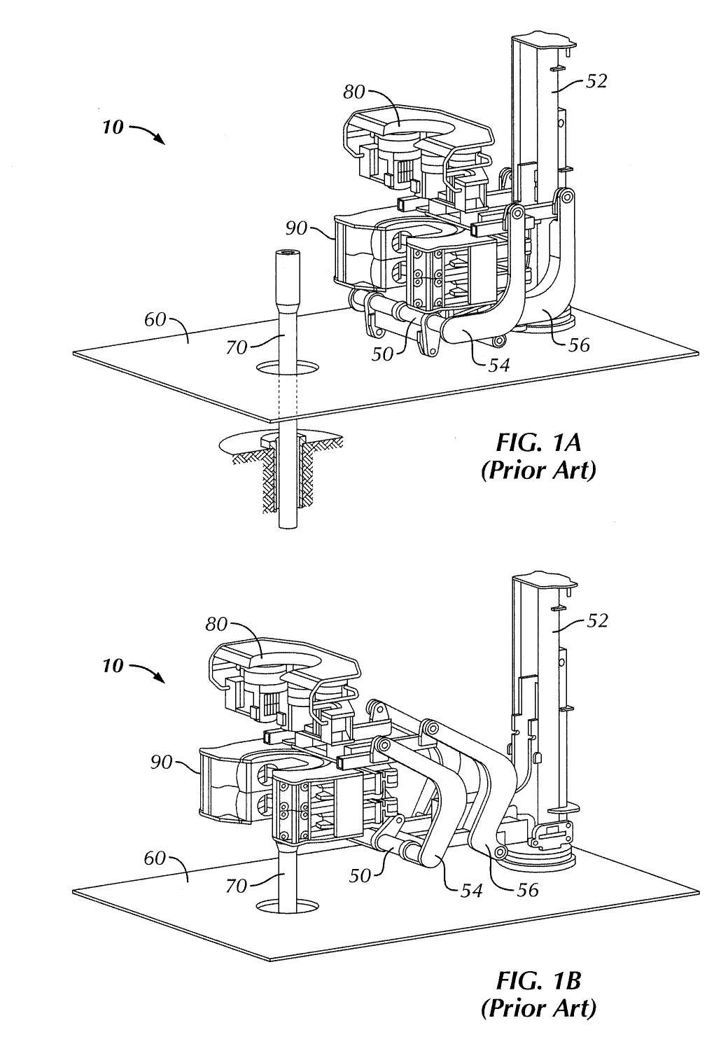

### DETAILED DESCRIPTION

In one aspect, embodiments disclosed herein relate to tubular handling systems. More particularly, embodiments disclosed herein relate to apparatus and methods to connect and disconnect tubular members.

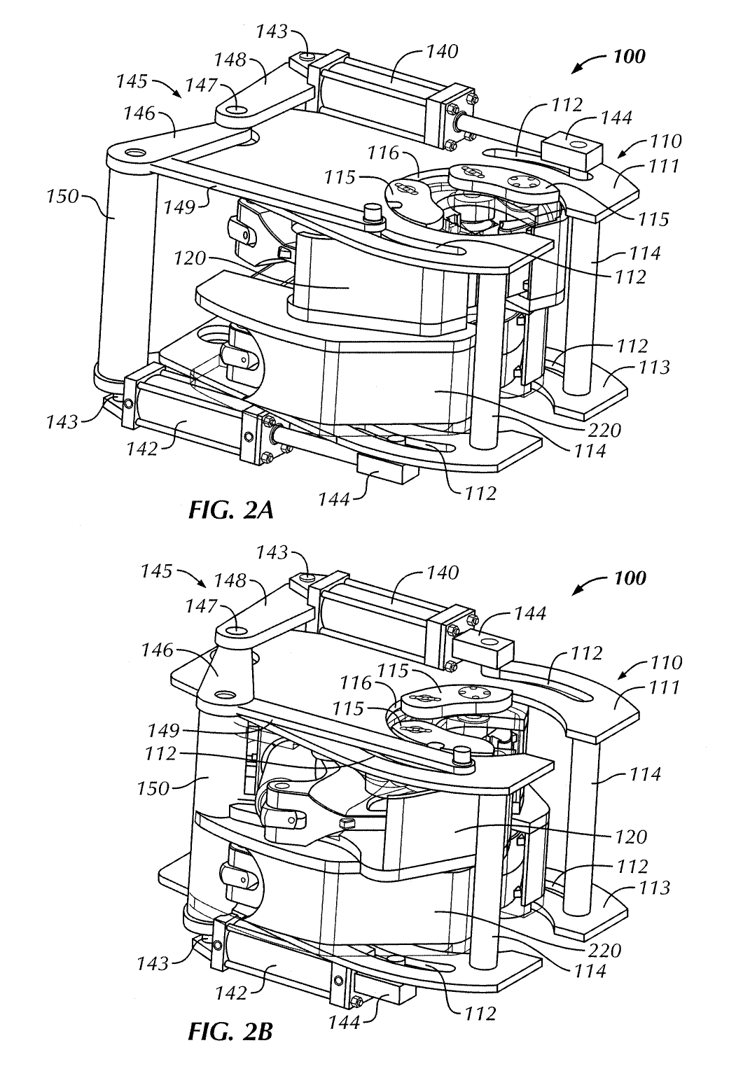

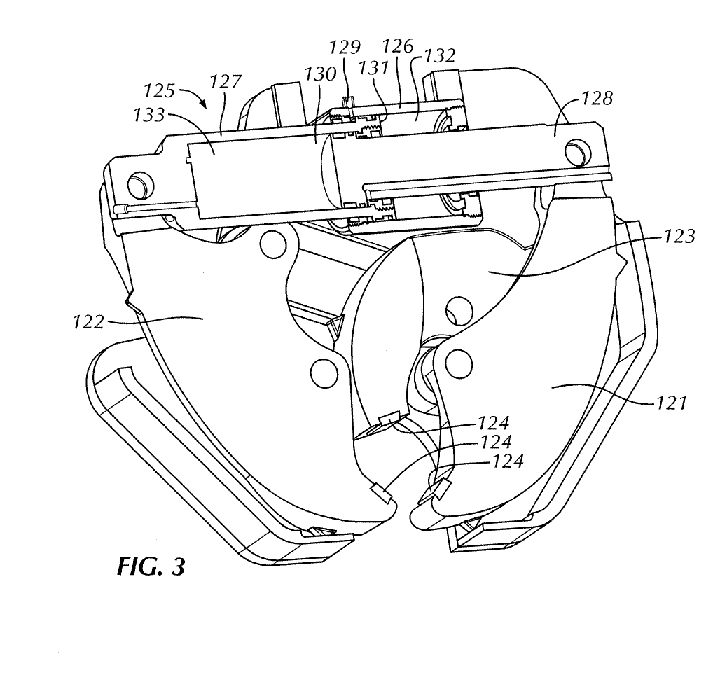

Referring now to FIGS. 2A and 2B, an assembly view of a torque wrench 100 is shown in accordance with embodiments of the present disclosure. Torque wrench 100 includes an upper jaw assembly 120 and a lower jaw assembly 220 which may be secured within a frame 110. Frame 110 includes an upper plate 111 and a lower plate 113 positioned above upper jaw assembly 120 and below lower jaw assembly 220, respectively. Supports 114 are configured to rigidly secure upper plate 111 and lower plate 113. Upper plate 111 and lower plate 113 may include guide slots 112 configured to receive attachments from a link system 145 and torque cylinders 140, 142, and to allow slideable movement of the attachments. Movement of the attachments in guide slots 112 allows upper jaw assembly 120 and lower jaw assembly 220 of torque wrench 100 to rotate.

Further, front ends of upper plate 111 and lower plate 113 are configured with circular cutouts 116 to receive the tubulars. The centers of upper and lower jaw assemblies 120, 220 may be aligned with cutouts 116 in upper and lower plates 111, 113. To facilitate rotation about a central axis, jaw assemblies 120, 220 may include a set of guides 115 which mate with and rotate along circular cutouts 116. Guides 115 may help to maintain proper alignment of separate tubulars are they are rotated, so as not to impart damage to the tubulars or the equipment.

Referring still to FIGS. 2A and 2B, link system 145 of torque wrench 100 may include upper link arms 146 and 148, which connect to each other at an upper center pivot 147 and to upper plate 111. A set of lower link arms (not shown) may connect to each other and to lower plate 113 in the same manner. Further, an upper extension arm 149 extends from upper link arm 146 to attach to upper plate 111 at guide slot 112. A lower extension arm (not shown) may also extend from a lower link arm and attach to lower plate 113 at guide slot 112 on the opposite side in the same manner. Further, upper link arm 146 may be attached to lower torque cylinder 142 by way of a shaft 150 at attachment 143.

Lower torque cylinder 142 includes a piston arm which extends to attach at 144 in the guide slot 112 of lower plate 113. Similarly, an upper torque cylinder 140 may be attached to the link arm 148 at 143, and also includes a piston arm which extends to attach at 144 in guide slot 112 of upper plate 111. Further, a shaft extends down from torque cylinder 140 to attach to a lower link arm and extension arm (not shown). Attachments between components in the link system 145 may include a pin and clevis configuration, or other attachment mechanisms known to those skilled in the art.

Torque wrench 100 is shown configured such that only one torque cylinder 140, 142, is required to operate each jaw assembly 120, 220, respectively. In the center pivot link configuration shown, extension arms 149 help with the rotation of the jaw assemblies 120, 220. For example, as the piston arms of torque cylinders 140, 142 are extended, extension arms 149 act as “retracted” piston arms of additional (i.e., non-existent) torque cylinders. Conversely, as the piston arms of torque cylinders 140, 142 are retracted, extension arms 149 act as “extended” piston arms of additional torque cylinders. Thus, extension arms 149 act as “dummy” piston cylinders such that the need for two torque cylinders per jaw assembly is removed.

As previously described, jaw assemblies 120, 220 may be rotated by corresponding torque cylinders 140, 142. Torque cylinder 140 moves upper jaw assembly 120, and torque cylinder 142 moves lower jaw assembly 220. Rotated positions of jaw assemblies 120, 220 are shown in FIGS. 2A and 2B. For example, a first position of jaw assemblies 120, 200 before rotation is shown in FIG. 2A, while a second position of jaw assemblies 120, 220 after rotation is shown in FIG. 2B. Further, FIG. 2A depicts arms of torque cylinders 140 and 142 extended, while FIG. 2B depicts the arms retracted.

Referring now to FIG. 3, a jaw assembly such as upper jaw assembly 120 and lower jaw assembly 220 is shown in accordance with embodiments of the present disclosure. Upper jaw assembly 120 and lower jaw assembly 220 may be identical and function in the same manner. Jaw assemblies 120, 220 include a first jaw 121, a second jaw 122, and in certain embodiments, an optional third jaw 123. First jaw 121 and second jaw 122 may be connected to a piston 125, and third jaw 123 (if present) may be mechanically linked to first jaw 121. Third jaw 123 may be configured such that when first jaw 121 is forced open or closed, third jaw 123 opens or closes as well. Third jaw 123 may be linked to first jaw 121 by a mechanical fastener, such as a pin or other mechanism known to those skilled in the art. Jaws 121, 122, 123 further include dies or grips 124 configured with teeth-like surfaces to engage and “grab” the tubulars and securely hold them.

A gripping cylinder 125 connects first jaw 121 and second jaw 122 and is configured to open and close the separate jaws (121, 122, 123) of jaw assembly 120. Gripping cylinder 124 may be connected to jaws 121, 122 with a clevis pin or other fastener known to those skilled in the art. Gripping cylinder 125 may be configured as a “double-acting” cylinder including an outer cylinder 126, a first piston arm 127, and a second piston arm 128. To extend piston arms 127, 128, hydraulic fluid is pumped through a fluid orifice 129 and enters a piston chamber 133 within first piston arm 127, and a cylinder chamber 132 within outer cylinder 126. To retract piston arms 127, 128, the hydraulic fluid may exit the chambers through fluid orifice 129, thereby opening the jaws and disengaging them from the tubular. Further, seals may be used between first piston arm 127 and second piston arm 128, between first piston arm 127 and outer cylinder 126, and between second piston arm 128 and outer cylinder 126. A person skilled in the art will understand the appropriate types and sizes of sealing elements that may be used.

When extending piston arms 127, 128 and closing the jaws around a tubular, the hydraulic fluid in piston chamber 133 provides a force against a piston arm face 130, and the hydraulic fluid in cylinder chamber 132 provides a force against a piston arm face 131. The hydraulic force against the faces allows the first piston arm 127 and the second piston arm 128 to extend, thereby closing jaws 121, 122, and 123 to engage a tubular. By having an increased surface area on which to apply the hydraulic pressure, double acting gripping cylinders 125 are configured to reduce the amount of hydraulic pressure needed to apply the required force on the tubular, and secure it in place during make up or break out operations. Alternatively, the same hydraulic pressure may be used, and an increased clamping force provided by the jaws around the tubular.

During operation of torque wrench 100, upper jaw assembly 120 and lower jaw assembly 220 are configured to rotate in opposite directions, thereby allowing them to rotate the tubulars to make-up or break-out a threaded connection. Torque cylinders 140, 142, and link system 145 may be used to rotate jaw assemblies 120, 220 in opposite directions. Referring back to FIGS. 2A and 2B, jaw assemblies 120, 220 may grip a first tubular and second tubular while in the first position (i.e., FIG. 2A). Jaw assemblies 120, 220 are then rotated to the second position (i.e., FIG. 2B), thereby rotating the first and second tubulars as well. Jaw assemblies 120, 220 may then be opened in order to disengage the tubulars and rotate back to the first position (FIG. 2A), to repeat the same process.

In certain embodiments, a bit breaker may attached to a bottom side of frame 110 (FIGS. 2A and 2B) and may be used in conjunction with lower jaw assembly 220. The bit breaker may be used to prevent a drill bit from turning while the tubular or bit sub to which the drill bit is attached is tightened or loosened. Since drill bits typically have non-cylindrical shapes, the torque wrenches used to used to tighten the tubular may not fit the bits properly. Further, many bits, such as polycrystalline diamond compact (“PDC”) bits, have a wide range of asymmetric shapes or profiles. Therefore, the bit breaker is configured to match the bit profile or shape in order to secure the bit.

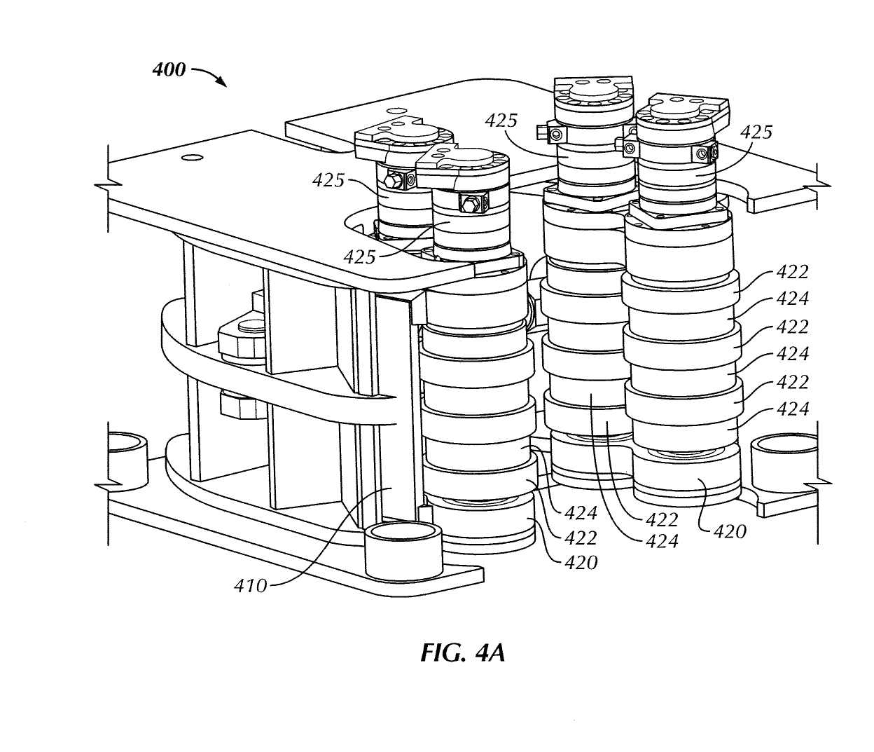

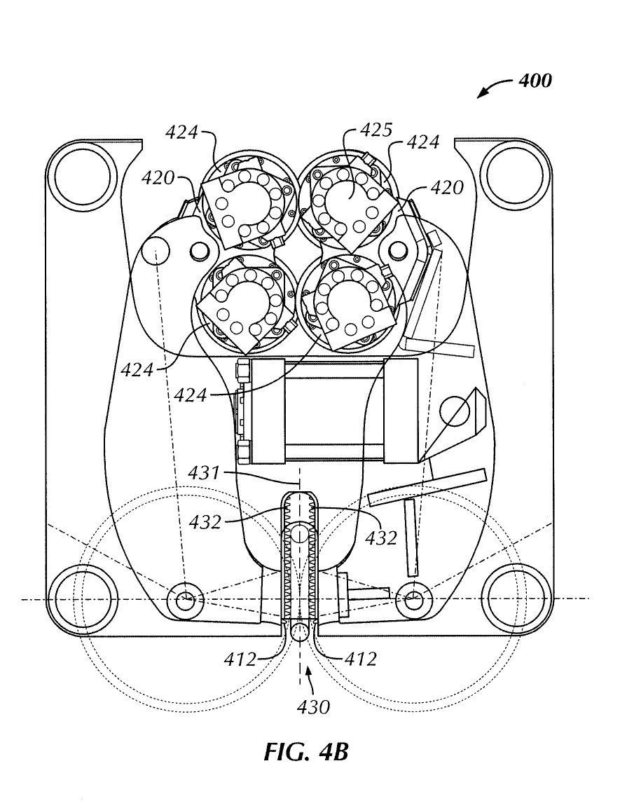

Referring now to FIGS. 4A and 4B, a spinner assembly 400 is shown in accordance with embodiments of the present disclosure. Spinner assembly 400 includes roller units 420 attached to arms 410. While two roller units 420 are shown, those skilled in the art will understand that additional roller units 420 may be used in alternative configurations. Spinner assembly 400 may be configured such that the roller units 420 adjust about a concentric center of a tubular. Further, roller units 420 are configured to adjust and concentrically engage an outer circumference of a tubular. Thus, spinner assembly 400 may center itself on the tubular regardless of the tubular diameter.

Roller units 420 may be attached to arms 410 with fasteners or other means known to those skilled in the art. As shown, each roller unit 420 includes rollers 424, which are configured to rotate as individual units. The rollers 424 are configured to rotate or “spin” the tubulars at higher velocities to reduce the amount of time required to assemble or disassemble tubular strings. After engaging a tubular, rollers 424 are configured to rotate in a first direction, thereby rotating or spinning the tubular in the opposite direction. Depending upon whether the connection is being made-up or broken-out, the directions may be reversed. Rollers 424 may be powered individually by motors 425 or by any other means as known to those skilled in the art. In certain embodiments, a variable speed hydraulic motor may be used to power rollers 424. The selected hydraulic motor may function first using a smaller internal stroke displacement while operating and rotating a tubular at a higher speed, after which, the hydraulic motor may be switched to a different mode, in which the motor uses a higher internal stroke displacement while rotating the tubular at a lower speed. For example, a low speed high torque (“LSHT”) Eaton Char-Lynn® hydraulic motor may be used, thereby providing a wide variety of speeds and torque ranges at which to operate the rollers during use.

A velocity governing device may be required to ensure that individual rollers 424 rotate at the same velocity during operation. Alternatively, roller unit 420 may include a synchronization mechanism to link rollers 424 on each roller unit 420, such that only a single motor is required for each roller unit 420.

Further, rollers 424 may include raised surfaces 422 to provide the necessary engagement area to properly grip and secure the tubular lengths. In certain embodiments, raised surfaces 422 may include grooves or teeth-like grips to better secure the tubular. A person of ordinary skill in the art will understand alternative configurations which may provide increased friction between rollers 424 and the tubulars.

Referring now to FIG. 4B, a top view of spinner assembly 400 is shown in accordance with embodiments of the present disclosure. Spinner assembly 400 includes a gear mechanism 430 used in adjusting the roller units 420 to different tubular diameters. Gear mechanism 430 includes a plurality of teeth 432 along both sides which are configured to correspond to pluralities of teeth 412 on the arms 410. As gear mechanism 430 moves along an axis 431, teeth 432 of gear mechanism 430 mesh with teeth 412 on both arms 410, and arms 410 are forced to “open” or “close.” In the configuration shown, as arms 410 open, roller units 420 expand to form a larger concentric circle to engage a larger tubular diameter. As arms 410 close, the concentric circle formed by roller units 420 is reduced to engage a smaller tubular diameter. Gear mechanism 430 may be powered by a motor or other device known to those skilled in the art.

The pluralities of teeth 432 along both sides of gear mechanism 430 are similarly configured (i.e., evenly and identically spaced), such that their engagement with the plurality of teeth 412 on each arm 410 is the same. In this way, as gear mechanism 430 is operated (moved along axis 431), arms 410 open and close by the same amount because of their engagement with gear mechanism 430. This further provides that arms 410 are always maintained at an equal distance from a central axis, and also that roller units 420, which are attached to arms 410, are always maintained about a concentric center (coincident with the central axis).

During operation, spinner assembly 400 and torque wrench 100 may be used in combination, though not simultaneously. Spinner assembly 400 is configured to provide higher velocities at lower torque, while torque wrench 100 is conversely configured to provide higher torque at lower velocities. Therefore, spinner assembly 400 may be used to initially thread two tubular lengths together quickly, though not to a specified amount of make-up torque, after which torque wrench 100 may be used to fully torque the threaded connection. On the other hand, torque wrench 100 may first break-out the connection from its make-up torque, after which spinner assembly 400 may “spin” the connection to quickly unthread it.

For example, when making up a tubular string, a box thread end of a first tubular may be secured in the lower jaw assembly of the torque wrench, while a pin thread end of a second tubular may be lowered towards the box end of the first tubular with a hoist. The spinner assembly may engage the second tubular and rotate or “spin” it at a relatively high velocity, thereby quickly threading the pin and box ends together. When the spinner assembly is unable to tighten the threaded connection further, the upper jaw assembly of the torque wrench may engage the pin end of the second tubular. The upper and lower jaw assemblies may then rotate in opposite directions to tighten the threaded connection to a specified make-up torque, which will be known to those skilled in the art.

Alternatively, when breaking out the threaded connections, the lower jaw assembly and the upper jaw assembly may engage the box end of a first tubular and the pin end of a second tubular, respectively. The jaw assemblies are rotated in opposite directions to break out or loosen the connection, at which point the spinner may engage the second tubular and rotate or “spin” it at a relatively high velocity to quickly unthread the connection. A hoist system or other lifting system may then lift the second tubular away from the tubular handling system.

Advantageously, embodiments of the present disclosure may provide a torque wrench requiring less hydraulic pressure to provide the same gripping force as a conventional torque wrench to grip tubulars. As previously described, the double acting gripping cylinders may be configured having twice the surface area of a conventional cylinder on which hydraulic pressure may build. Thus, the same gripping force may be applied to a tubular with about half the hydraulic pressure usually required. Alternatively, if required, the hydraulic pressure as typically applied may be used, thereby providing double the gripping force of conventional cylinders. Therefore, the ability to quickly make-up or break out connections may increase productivity and reduce rig time costs.

Further, the spinner provides the ability to concentrically center a tubular length regardless of the diameter of the tubular. Previously, the use of different tubular diameters may require manual adjustments to be made to the spinner assembly before proceeding with the operation. Extra rig hands or tools may further be required to make these adjustments. Embodiments disclosed herein provide an automatically adjusting spinner assembly which may remove the need for such manual adjustments, saving time and money.

Still further, the center pivot link system described in embodiments disclosed herein may be advantageous in that it requires only one torque cylinder per jaw assembly. As such, an additional piece of equipment (i.e., a torque cylinder) is replaced with a simple component (i.e., extension arm 149). This substitution and reduction in tool complexity may reduce the amount of maintenance required for the equipment, and therefore reduce the likelihood of equipment failure. In the event of a torque wrench failure, the amount of time spent repairing the equipment would be very expensive in terms of rig downtime. Embodiments disclosed herein work to reduce downtime and reduce maintenance of rig time costs.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A tubular handling system comprising:
a plurality of roller units configured to engage and rotate a first tubular, wherein the roller units are configured to adjust about a concentric center of the first tubular;
an upper jaw assembly comprising a double-acting gripping cylinder, the upper jaw assembly configured to grip the first tubular;
a lower jaw assembly including a double-acting gripping cylinder, the lower jaw assembly configured to grip a second tubular;
a first torque cylinder configured to rotate the upper jaw assembly in a first direction relative to the lower jaw assembly;
a second torque cylinder configured to rotate the lower jaw assembly in an opposite direction relative to the upper jaw assembly.

2. The system of claim 1, wherein at least one of the upper jaw assembly and the lower jaw assembly further comprise a first jaw and a second jaw operated by the double-acting gripping cylinder.

3. The system of claim 2, wherein at least one of the upper jaw assembly and the lower jaw assembly further comprise a third jaw, wherein the third jaw is mechanically linked to the second jaw.

4. The system of claim 1, wherein at least one of the double-acting cylinders comprise a first piston arm face and a second piston arm face, wherein a hydraulic fluid applies pressure on the first and second piston arm faces in opposite directions.

5. The system of claim 1, further comprising a center pivot double-link attachment configured to mechanically connect the first torque cylinder and the second torque cylinder.

6. The system of claim 1, wherein the upper and lower jaw assemblies are mounted within a frame.

7. The system of claim 6, wherein the frame comprises grooves for the attachment of piston arms and extension arms.

8. The system of claim 1, wherein the roller units comprise individual rollers configured to engage and rotate the tubulars.

9. The system of claim 8, further comprising motors configured to rotate each of the individual rollers.

10. The system of claim 9, wherein the motors comprise a velocity governing device to maintain equal velocities among the individual rollers.

11. The system of claim 8, wherein the roller units comprise a synchronization mechanism between the individual rollers on each roller unit.

12. The system of claim 1, further comprising a gear mechanism configured to adjust the roller units evenly about a concentric center.

13. A tubular handling system comprising:
an upper jaw assembly comprising a double-acting gripping cylinder, the upper jaw assembly configured to grip the first tubular;
a lower jaw assembly including a double-acting gripping cylinder, the lower jaw assembly configured to grip a second tubular;
a first torque cylinder configured to rotate the upper jaw assembly in a first direction relative to the lower jaw assembly;
a second torque cylinder configured to rotate the lower jaw assembly in an opposite direction relative to the upper jaw assembly.

14. The system of claim 13, wherein at least one of the upper jaw assembly and the lower jaw assembly further comprise a first jaw and a second jaw operated by the double-acting gripping cylinder.

15. The system of claim 14, wherein at least one of the upper jaw assembly and the lower jaw assembly further comprise a third jaw, wherein the third jaw is mechanically linked to the second jaw.

16. The system of claim 13, wherein the double-acting cylinder comprises a first piston arm face and a second piston arm face, wherein a hydraulic fluid applies pressure on the first and second piston arm faces in opposite directions.

17. The system of claim 13, further comprising a center pivot double-link attachment configured to mechanically connect the first torque cylinder and the second torque cylinder.

18. A tubular handling system comprising:
a plurality of roller units attached to arms, the roller units configured to engage and rotate a first tubular;
a gear mechanism configured to engage ends of the arms, wherein the gear mechanism is configured to open and close the arms;
wherein the arms are configured to maintain the roller units about a concentric center of the first tubular.

19. The system of claim 18, wherein the arms comprise a plurality of teeth to engage the gear mechanism.

20. A method to make-up a tubular connection, the method comprising:
engaging a first tubular with a plurality of automatically adjustable roller units, wherein the roller units are configured to concentrically center about a center of the first tubular;
rotating the first tubular with multiple rollers mounted on the roller units;
activating a double-acting cylinder connected to a lower jaw assembly to secure a second tubular;
activating a double-acting cylinder connected to an upper jaw assembly to secure the first tubular;
rotating the upper jaw assembly and the lower jaw assembly in opposite directions to make-up the tubular connection.

21. The method of claim 20, further comprising rotating the upper jaw assembly and the lower jaw assembly in opposite directions to break-out the tubular connection.

22. The method of claim 20, wherein the double-acting cylinders provide an increased clamping force on the tubulars

23. A method to make-up a tubular connection, the method comprising:
activating a double-acting cylinder connected to a lower jaw assembly to secure a second tubular;
activating a double-acting cylinder connected to an upper jaw assembly to secure the first tubular;
rotating the upper jaw assembly and the lower jaw assembly in opposite directions to make-up the tubular connection.

24. The method of claim 23, further comprising rotating the upper jaw assembly and the lower jaw assembly in opposite directions to break-out the tubular connection.

25. The method of claim 23, wherein the double-acting cylinders provide an increased clamping force on the tubulars.
